(19) United States
(12) Patent Application Publication
(10) Pub. No.: US 2025/0349942 A1
(43) Pub. Date: Nov. 13, 2025

(54) HEAT INSULATING SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Jung Hyo LEE, Suwon-si (KR); A Rum YU, Suwon-si (KR); Myung Heui WOO, Suwon-si (KR); Hye Jin PARK, Suwon-si (KR); Seung Yong YANG, Suwon-si (KR); Jae Hyun LEE, Suwon-si (KR); Ha Na RA, Suwon-si (KR); Yun Sung YANG, Suwon-si (KR)

(73) Assignee: SAMSUNG SDI CO., LTD., Yongin-si (KR)

(21) Appl. No.: 19/202,674

(22) Filed: May 8, 2025

(30) Foreign Application Priority Data
May 9, 2024 (KR) 10-2024-0060923

(51) Int. Cl. H01M 10/658; H01M 10/052; H01M 50/209

(52) U.S. Cl. CPC H01M 10/658; H01M 10/052; H01M 50/209; H01M 2220/20

(57) ABSTRACT

Examples of the present disclosure relate to a heat insulating sheet for a rechargeable lithium battery, and a rechargeable lithium battery module including the heat insulating sheet. The heat insulating sheet for a rechargeable lithium battery includes a first base layer and an aerogel-containing layer that are stacked together. The aerogel-containing layer includes a fibrous support, an aerogel, a first binder, and a second binder, and the second binder is a meltable binder with a melting point that ranges from about 30° C. to about 80° C.

### CROSS-REFERENCE TO RELATED APPLICATION

The present application claims priority to Korean Patent Application No. 10-2024-0060923, filed on May 9, 2024 in the Korean Intellectual Property Office, and the entire disclosure of which is incorporated herein by reference.

### BACKGROUND

### 1. Field of the Disclosure

The present disclosure relates to a heat insulating sheet for a rechargeable lithium battery, and a rechargeable lithium battery module including the heat insulating sheet.

### 2 Discussion of Related Art

With increasing presence of electronic devices that use batteries, such as, e.g., mobile phones, laptop computers, electric vehicles, and the like, the demand for rechargeable batteries with high energy density and high capacity has increased. Accordingly, improving performance of rechargeable lithium batteries may be advantageous.

A rechargeable lithium battery typically includes a positive electrode and a negative electrode including an active material which allows for intercalation and deintercalation of lithium ions and an electrolyte, and produces electrical energy through an oxidation-reduction reaction taking place when the lithium ions are intercalated and deintercalated to and from the positive electrode and the negative electrode.

A plurality of rechargeable lithium batteries may be included to form a rechargeable lithium battery module. It may be advantageous for heat propagation and/or heat transfer to be reduced or blocked between adjacent cells in the rechargeable lithium battery module.

### SUMMARY

One example embodiment includes a heat insulating sheet for a rechargeable lithium battery that has desired or improved heat insulating performance, desired or improved adhesion between a base layer and an aerogel-containing layer, and desired or improved dust resistance, punchability, and flexibility.

Another example embodiment includes a rechargeable lithium battery module including the heat insulating sheet for a rechargeable lithium battery.

A heat insulating sheet for a rechargeable lithium battery according to one example embodiment includes a first base layer and an aerogel-containing layer that are stacked, e.g., sequentially stacked, wherein the aerogel-containing layer includes a fibrous support, an aerogel, a first binder, and a second binder, and the second binder is a meltable binder with a melting point that ranges from about 30° C. to about 80° C.

Another example embodiment includes a rechargeable lithium battery module including a plurality of battery cells that face each other; and heat insulating sheets for a rechargeable lithium battery that are disposed between the plurality of battery cells.

### BRIEF DESCRIPTION OF THE DRAWINGS

FIG. 1 is a cross-sectional view of a heat insulating sheet for a rechargeable lithium battery, according to one example embodiment.

FIG. 2 is a cross-sectional view of a heat insulating sheet for a rechargeable lithium battery, according to another example embodiment.

FIG. 3 is a perspective view of a rechargeable lithium battery module, according to one example embodiment.

FIG. 4 is an exploded perspective view of the rechargeable lithium battery module, according to one example embodiment.

FIG. 5 is a cross-sectional view schematically showing a battery cell, according to one example embodiment.

FIG. 6 is a cross-sectional view schematically showing a battery pack, according to one example embodiment.

FIG. 7 is a cross-sectional view schematically showing a battery pack, according to one example embodiment.

FIG. 8 is a view illustrating a vehicle body and vehicle body components, according to one example embodiment.

FIG. 9 is a view illustrating a vehicle body and vehicle body components, according to one example embodiment.

### DETAILED DESCRIPTION

Hereinafter, example embodiments of the present disclosure are described in detail. However, the example embodiments are presented as examples, and the present disclosure is not limited by the example embodiments. The present disclosure is defined only by the scope of the claims below.

Unless particularly mentioned otherwise in the present specification, when a part such as a layer, film, region, plate, or the like is described as being “on” another part, this not only includes a case in which the part is “directly on” the other part, but also includes a case in which still another part is present therebetween.

Unless particularly mentioned otherwise in the present specification, a singular expression may include a plural expression. Further, unless particularly mentioned otherwise, “A or B” may indicate including A, including B, or including A and B.

In the present specification, “a combination thereof” may indicate a mixture, stack, composite, copolymer, alloy, blend, and reaction product of constituents.

When the terms “about” or “substantially” are used in this specification in connection with a numerical value, it is intended that the associated numerical value include a tolerance of ±10% around the stated numerical value. When ranges are specified, the range includes all values therebetween such as increments of 0.10%.

### Heat Insulating Sheet for Rechargeable Lithium Battery:

A heat insulating sheet for a rechargeable lithium battery according to one example embodiment includes a first base layer and an aerogel-containing layer that are stacked, e.g., sequentially stacked, wherein the aerogel-containing layer includes a fibrous support, an aerogel, a first binder, and a second binder, and the second binder is a meltable binder with a melting point that ranges from about 30° C. to about 80° C.

The heat insulating sheet according to one example embodiment may further include a second base layer stacked on the aerogel-containing layer.

By including the meltable binder that has a melting point that ranges from about 30° C. to about 80° C., the heat insulating sheet can provide desired or improved adhesion between the first base layer and the aerogel-containing layer. The desired or improved adhesive strength can provide flexibility by lowering the flexural modulus of the heat insulating sheet, and can improve the punchability and dust resistance thereof.

Hereinafter, a heat insulating sheet according to one example embodiment is described in detail.

The heat insulating sheet includes a first base layer and an aerogel-containing layer that are stacked, e.g., sequentially stacked, together. The heat insulating sheet may include the first base layer, the aerogel-containing layer, and a second base layer that are stacked, e.g., sequentially stacked, together.

### First Base Layer

The first base layer may support the aerogel-containing layer, and the second base layer in the heat insulating sheet.

The first base layer may be included as one or more layers, that is, one layer, or two or more layers, in the heat insulating sheet.

The first base layer may be or include a film, a thin film, or a sheet that is formed of or that includes at least one of a resin, a metal-based inorganic material, a nonmetal-based inorganic material, or a composite thereof or includes the same.

For example, the resin may include one or more of a polyolefin-based resin such as polyethylene or polypropylene, a polystyrene-based resin, a polyester-based resin such as polyethylene terephthalate or polybutylene terephthalate, a polyamide-based resin, and a polyimide-based resin.

For example, the metal-based inorganic material may include one or more of copper, nickel, cobalt, iron, chromium, vanadium, palladium, ruthenium, rhodium, molybdenum, tungsten, iridium, silver, gold, and platinum. The metal-based inorganic material may undergo anti-corrosion treatment, insulation treatment, or the like, when necessary.

The nonmetal-based inorganic material may include one or more of calcium carbonate, talc, and mica.

According to one example embodiment, the heat insulating sheet may include a nonmetal-based inorganic material, for example, a mica sheet. Mica may facilitate the increase in the heat insulating performance and the durability of the heat insulating sheet.

The thickness of the first base layer may range from about 10 μm to about 5,000 μm, for example, from 50 μm to 3,000 μm, or from 100 μm to 1,000 μm. Within the above range, the first base layer may be included in the heat insulating sheet.

### Aerogel-Containing Layer

The aerogel-containing layer may be or include a separate layer that is independent of the first base layer. Here, “separate layer that is independent of” indicates that the first base layer and the aerogel-containing layer are completely separated, noncontinuous layers, instead of the aerogel-containing layer being formed through impregnation or the like in the first base layer.

The aerogel-containing layer may be included as one or more layers, that is, one layer or two or more layers, in the heat insulating sheet.

The aerogel-containing layer includes a fibrous support, an aerogel, a first binder, and a meltable binder that has a melting point that ranges from about 30° C. to about 80° C. as a second binder.

The fibrous support may help to support the aerogel-containing layer and improve the compressive properties of the heat insulating sheet.

The fibrous support may be or include, for example, a wool mat or a chopped strand mat.

Fibers constituting the fibrous support may include one or more of natural fibers, glass fibers, carbon fibers, graphite fibers, mineral fibers, and polymer fibers. For example, the compressive properties of the heat insulating sheet may be further increased when the glass fibers are included as the fibrous support.

The natural fibers may be or include fibers made of or including one or more of hemp, jute, flax, coir, kenaf, and cellulose. The mineral fibers may be fibers made of or including one or more of basalt, wollastonite, alumina, silica, slag, and rock. The polymer fibers may include one or more of nylon-based fibers, polyimide-based fibers, polyamide-based fibers, polybenzimidazole-based fibers, polybenzoxazole-based fibers, polyamideimide-based fibers, polyester-based fibers such as polyethylene terephthalate or polybutylene terephthalate, and polyolefin-based fibers such as polyethylene or polypropylene.

For example, the fibrous support may be or include glass wool.

Fibers in the fibrous support may have an aspect ratio in a range of about 1 or more, for example, an aspect ratio ranging from about 1 to about 5,000. Within the above range, the aerogel-containing layer can be substantially firmly formed, and the durability of the heat insulating sheet can be increased. Herein, “aspect ratio” refers to a ratio of a fiber length to a fiber diameter in the fibrous support.

The fibers in the fibrous support may have a length ranging from about 50 μm to about 1,000 μm, for example, from 70 μm to 800 μm, or from 100 μm to 600 μm. Within the above range, the aerogel-containing layer can be firmly formed, and the durability of the heat insulating sheet can be increased.

The fibers in the fibrous support may have a diameter ranging from about 0.1 μm to about 20 μm, for example, from 0.1 μm to 15 μm, from 0.1 μm to 5 μm, from 1 μm to 15 μm, or from 3 μm to 10 μm. Within the above range, the aerogel-containing layer can be firmly formed, and the durability of the heat insulating sheet can be increased. Here, “diameter” may refer to a diameter when the fibers have a circular cross-section, and may refer to the longest diameter when the cross-section is not circular.

The fibrous support may be included in an amount ranging from about 5 wt % to about 70 wt % in the aerogel-containing layer. For example, the fibrous support may be included in an amount ranging from 25 wt % to 60 wt % or from 30 wt % to 50 wt % in the aerogel-containing layer. Within the above range, it may be possible to increase the flexibility and durability of the heat insulating sheet.

The aerogel may provide a heat insulating effect to the aerogel-containing layer.

According to one example embodiment, the aerogel may have a specific surface area ranging from about 500 m²/g to about 1,000 m²/g. For example, the specific surface area may range from 500 m²/g to 950 m²/g, from 550 m²/g to 950 m²/g, or from 600 m²/g to 900 m²/g.

Within the above range, it may be possible to reduce or prevent heat transfer and heat propagation between a plurality of battery cells. Herein, “specific surface area” may be a specific surface area based on Brunauer, Emmett and Teller (BET) specific surface area analysis.

According to one example embodiment, the aerogel may have an average particle diameter ranging from about 5 μm to about 200 μm. For example, the aerogel may have an average particle diameter ranging from 10 μm to 100 μm, or from 20 μm to 50 μm. Within the above range, it may be possible to delay heat transfer between a plurality of battery cells by increasing the heat insulating performance of the heat insulating sheet. Herein, “particle diameter” refers to an average particle diameter D50 which is a diameter of a particle with a cumulative volume of 50% by volume in a particle diameter distribution. The average particle diameter D50 may be measured by methods known to those skilled in the art. For example, the average particle diameter D50 may be measured using a particle size analyzer, a transmission electron microscope photograph, or a scanning electron microscope photograph. As another method, an average particle diameter D50 value may be obtained by measuring the particle diameter using a measuring device using dynamic light-scattering, performing data analysis to count the number of particles for each particle size range, and then calculating the particle diameter therefrom. Alternatively, an average particle diameter D50 may be measured using a laser diffraction method. For example, when measuring an average particle diameter D50 using a laser diffraction method, particles to be measured may be dispersed in a dispersion medium, introduced into a commercially available laser diffraction particle diameter measurement apparatus (for example, MT3000 of Microtrac, Inc.), and irradiated with ultrasonic waves of about 28 kHz at an output of 60 W, and then the average particle diameter D50 may be calculated based on 50% of a particle diameter distribution in the measurement apparatus.

The aerogel may be included in an amount ranging from about 10 wt % to about 90 wt % in the aerogel-containing layer. For example, the aerogel may be included in an amount ranging from 30 wt % to 70 wt % or from 40 wt % to 60 wt % in the aerogel-containing layer. Within the above range, the heat insulating performance of the heat insulating sheet can be increased.

The first binder may facilitate increasing the dust resistance of the heat insulating sheet.

According to one example embodiment, the first binder may be or include an aqueous binder. The aqueous binder may facilitate the formation of the aerogel-containing layer due to being highly soluble in water among solvents described below.

According to one example embodiment, the aqueous binder may include one or more of a cationic aqueous polymer, an anionic aqueous polymer, and a nonionic aqueous polymer.

The cationic aqueous polymer may be or include a polymer having a functional group such as or including at least one of an amine group, an ammonium group, a phosphonium group, a sulfonium group, or a salt thereof, for example, a polymer having an amine group. For example, the cationic aqueous polymer may include one or more of polyethylene amine and polyamine.

The anionic aqueous polymer may be or include a polymer having a functional group such as at least one of a carboxylic acid group, a sulfonic acid group, an ester group, a phosphoric acid ester group, or a salt thereof, for example, a polymer having a carboxylic acid group. For example, the anionic aqueous polymer may be or include polymaleic acid.

The nonionic aqueous polymer may include one or more of polyvinyl alcohol, polyethylene glycol, polyacrylamide, polyvinyl pyrrolidone, polyurethane, and polyester. The nonionic aqueous polymer may be or include a water-dispersible or aqueous polymer.

According to one example embodiment, the binder may include a mixture of one or more of polyvinyl alcohol, polyethylene glycol, polyacrylamide, and polyvinyl pyrrolidone, as well as one or more of polyurethane and polyester. In this case, it may be possible to provide dispersion characteristics by one or more of polyvinyl alcohol, polyethylene glycol, polyacrylamide, and polyvinyl pyrrolidone, and fire resistance properties by one or more of polyurethane and polyester. For example, a mixture of polyvinyl alcohol and polyurethane may be included.

According to one example embodiment, a weight ratio of one or more of polyvinyl alcohol, polyethylene glycol, polyacrylamide, and polyvinyl pyrrolidone to one or more of polyurethane and polyester may range from about 1:1 to about 1:5, for example, from 1:1 to 1:4 or from 1:2 to 1:3. Within the above range, the heat insulating performance, dust resistance, fire resistance, and mechanical properties of the heat insulating sheet can be improved.

The first binder may be included in an amount ranging from about 0.5 wt % to about 20 wt % in the aerogel-containing layer. For example, the first binder may be included in an amount ranging from 2 wt % to 15 wt %, from 4 wt % to 15 wt %, or from 4 wt % to 10 wt % in the aerogel-containing layer. Within the above range, it may be possible to improve the dust resistance of the heat insulating sheet.

The meltable binder with a melting point that ranges from about 30° C. to about 80° C., which is the second binder, may be included in the aerogel-containing layer to increase the adhesion between the base layer and the aerogel-containing layer. This increased adhesion may improve the flexibility, punchability, dust resistance, and handlability of the heat insulating sheet. For example, the aerogel-containing layer may include the meltable binder with a melting point that ranges from about 30° C. to about 80° C. as the second binder, instead of including an excessive amount of the first binder, to increase the aerogel content in the aerogel-containing layer, and in this way, also improve heat insulating performance.

A process of drying a composition for the aerogel-containing layer is included in the preparation of the aerogel-containing layer, and in the drying process, by melting the meltable binder that has a melting point that ranges from about 30° C. to about 80° C., the degree of adhesion between the aerogel-containing layer and the first base layer is increased, thereby increasing the adhesion between the aerogel-containing layer and the first base layer. Due to heat generated in the process of drying the aerogel composition, the fluidity of the aerogel-containing layer increases, and the aerogel-containing layer diffuses on the surface of the first base layer, and when the aerogel composition is left at room temperature again, the aerogel composition is crystallized again on the surface to which the aerogel composition is adhered, and due to the anchorage effect, the adhesion between the aerogel-containing layer and the first base layer and/or the second base layer can be increased.

The meltable binder has a melting point ranging from about 30° C. to about 80° C. When the melting point is in a range of about 30° C. or more, an effect of increasing the adhesion between the aerogel-containing layer and the first base layer can be expected in the process of manufacturing the heat insulating sheet, and when the melting point is in a range of about 80° C. or less, since a side chain part of the binder does not change the fluidity of a crystallized part, the increase in peel strength may be desired or improved.

In one example embodiment, the meltable binder may have a melting point ranging from about 30° C. to about 80° C., for example, from 35° C. to 50° C. Within the above range, the increase in peel strength may be desired or improved.

According to one example embodiment, the first binder, for example, the above-described aqueous binder, may have a higher melting point than the meltable binder that has a melting point that ranges from about 30° C. to about 80° C.

The composition of the meltable binder is not particularly limited as long as the above-mentioned melting point range can be reached. The meltable binder may be formed of or include one monomer, or formed of or include two or more monomers. For example, the meltable binder may be formed of or include a monomer mixture including two or more monomers to readily reach the melting point range of the present disclosure.

The composition of the meltable binder that has a melting point that ranges from about 30° C. to about 80° C. is not particularly limited, as long as the above-mentioned melting point range can be provided. For example, the binder that has a melting point that ranges from about 30° C. to about 80° C. may include a copolymer of a monomer mixture including (meth)acrylate having a linear or branched long-chain alkyl group at an ester site.

According to one example embodiment, the (meth)acrylate having a linear or branched long-chain alkyl group may be or include (meth)acrylate having a C16 to C22 linear or branched alkyl group. For example, the (meth)acrylate may include one or more of stearyl (meth)acrylate and cetyl (meth)acrylate.

In the monomer mixture, the (meth)acrylate having a linear or branched long-chain alkyl group may be included in an amount of about 100 mol % or less, for example, an amount ranging from about 70 mol % to 100 mol %, from 70 mol % to 99 mol %, or from 90 mol % to 99 mol %. Within the above range, the melting point range of the binder can be readily reached, and peel strength can be increased in the drying process.

The monomer mixture may further include a comonomer that is different from the (meth)acrylate having a linear or branched long-chain alkyl group.

The comonomer may be copolymerized with the (meth)acrylate having a linear or branched long-chain alkyl group to form the binder.

The comonomer may include one or more of a non-silicon-based monomer not containing silicon, and a silicon-based monomer containing silicon.

The non-silicon-based monomer may be or include (meth)acrylate in which the carbon number of an alkyl group at an ester site is smaller compared to the carbon number of the (meth)acrylate having a linear or branched long-chain alkyl group. For example, the non-silicon-based monomer may include (meth)acrylate having a linear or branched alkyl group which carbon number is 10 or less, for example, 4 to 10, at an ester site. For example, the non-silicon-based monomer may include t-butyl (meth)acrylate.

The silicon-based monomer may include silicon-modified monofunctional (meth)acrylate. For example, the silicon-based monomer may include a compound of Chemical Formula 1 below:

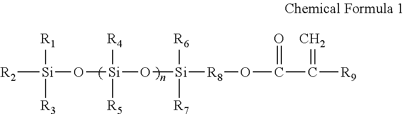

In Chemical Formula 1 above,
R₁, R₂, R₃, R₄, R₅, R₆, and R₇ are or include, each independently, hydrogen, a C1 to C10 alkyl group, a C3 to C10 cycloalkyl group, or a C6 to C10 aryl group,
R₈ is or includes a C1 to C10 alkylene group or a C6 to C10 arylene group,
R₉ is or includes hydrogen or a methyl group, and n is an integer in a range from 10 to 100.

The silicon-based monomer may include a compound of Chemical Formula 2 below:

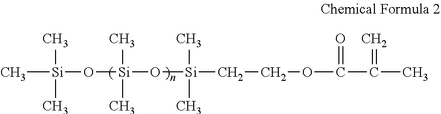

In Chemical Formula 2 above, n is an integer in a range from 10 to 100.

A product prepared by a typical method known to those skilled in the art or a commercially available product may be included as the silicon-based monomer.

The comonomer may be included in an amount ranging from about 1 mol % to about 30 mol %, for example, from 1 mol % to 10 mol %, in the monomer mixture. Within the above range, the heat insulating performance of the aerogel may not be affected.

The meltable binder which melting point ranges from about 30° C. to about 80° C., which is the second binder, may be included in an amount ranging from about 0.1 wt % to about 15 wt % in the aerogel-containing layer. For example, the second binder may be included in an amount ranging from 0.5 wt % to 10 wt % or from 1 wt % to 7 wt % in the aerogel-containing layer. Within the above range, the second binder may have an effect of increasing the adhesion between the aerogel-containing layer and the first base layer, and may not affect the improvement of the heat insulating performance of the heat insulating sheet.

According to one example embodiment, a weight ratio of the meltable binder which melting point ranges from about 30° C. to about 80° C., which is the second binder, to the first binder, for example, the aqueous binder, may range from about 1:1 to about 1:200, for example, from 1:1 to 1:10. Within the above range, heat insulating performance, adhesive strength, dust resistance, and punchability can be improved in a balanced manner.

The aerogel-containing layer may further include one or more of a dispersant and a silane-based compound.

The dispersant may improve the dispersion of the aerogel in the composition for the aerogel-containing layer, thereby enabling the preparation of an aerogel-containing layer in which the fibrous support and the aerogel are uniformly dispersed.

The dispersant may include one or more of a surfactant and a phosphorous-based salt. The surfactant may include one or more of a nonionic surfactant, an anionic surfactant, and a cationic surfactant. The surfactant may include one or more of a natural surfactant such as lecithin, and a non-natural surfactant such as a chemical. The phosphorous-based salt may be or include a phosphate-based salt.

The dispersant may be included in an amount ranging from about 0.1 wt % to about 6 wt % in the aerogel-containing layer. For example, the dispersant may be included in an amount ranging from 0.1 wt % to 5 wt % or from 0.1 wt % to 3 wt %. Within the above range, the composition for the aerogel-containing layer can be prepared at a low cost, and a heat insulating sheet with improved heat insulating performance, durability, and dust resistance can be provided.

According to one example embodiment, the first binder:the dispersant weight ratio may range from about 1:0.001 to about 1:0.7, for example, from 1:0.001 to 1:0.67, from 1:0.001 to 1:0.5, or from 1:0.001 to 1:0.3. Within the above range, when the binder and the dispersant are included together, it is possible to prepare an aerogel-containing layer in which the aerogel is further substantially uniformly dispersed.

The silane-based compound may improve the dispersibility of the aerogel in the aerogel-containing layer.

According to one example embodiment, the silane-based compound may include one or more of an alkyl group-containing trialkoxysilane such as methyltrimethoxysilane, methyltriethoxysilane, ethyltrimethoxysilane, ethyltriethoxysilane, or octadecyltrimethoxysilane, an epoxy group-containing trialkoxysilane such as glycidoxpropyltrimethoxysilane, and an unsaturated group-containing trialkoxysilane such as 3-(trimethoxysilyl) propyl methacrylate.

The aerogel-containing layer may further include a typical additive known to those skilled in the art. The additive may include one or more of a wetting agent, an emulsifier, a compatibilizer, a viscosity modifier, a pH regulator, a stabilizer, an antioxidant, an acid or base capturing agent, a metal deactivator, a defoamer, an antistatic agent, a thickener, an adhesion promoter, a bonding agent, a flame retardant, an impact modifier, a pigment, a dye, a colorant, and a deodorant.

According to one example embodiment, the aerogel-containing layer may have a thickness ranging from about 100 μm to about 10,000 μm, for example, from 500 μm to 5,000 μm or from 1,000 am to 3,000 μm. An aerogel-containing layer having a thickness within the above range may be included in the heat insulating sheet.

### Second Base Layer

The second base layer may support the first base layer and the aerogel-containing layer in the heat insulating sheet.

The second base layer may be included as one or more layers, that is, one layer, or two or more layers, in the heat insulating sheet.

The second base layer may be stacked on the aerogel-containing layer. The aerogel-containing layer may be a separate layer that is independent of the second base layer. H ere, “separate layer that is independent of” indicates that the second base layer and the aerogel-containing layer are completely separated, noncontinuous layers, instead of the aerogel-containing layer being formed through impregnation or the like in the second base layer.

The second base layer may be or include a film, a thin film, or a sheet that is formed of or that includes a resin, a metal-based inorganic material, a nonmetal-based inorganic material, or a composite thereof or includes the same. The resin, metal-based inorganic material, and nonmetal-based inorganic material are substantially the same as the resin, metal-based inorganic material, and nonmetal-based inorganic material described for the first base layer.

According to one example embodiment, the heat insulating sheet may include a nonmetal-based inorganic material as the second base layer. For example, the heat insulating sheet may include mica. Mica may increase the heat insulating performance and durability of the heat insulating sheet.

The second base layer may have a thickness ranging from about 10 μm to about 5,000 μm, for example, from 50 μm to 3,000 μm or from 100 am to 1,000 μm. A second base layer having a thickness within the above range may be included in the heat insulating sheet.

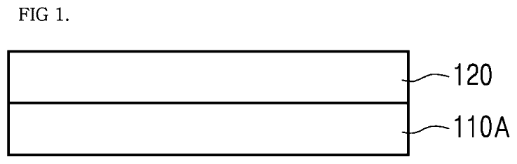

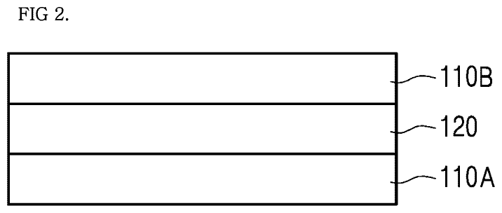

FIGS. 1 and 2 are cross-sectional views of a heat insulating sheet, according to one embodiment.

Referring to FIG. 1, a heat insulating sheet may include a first base layer 110A and an aerogel-containing layer 120 stacked on one surface of the first base layer 110A.

Referring to FIG. 2, a heat insulating sheet may include a first base layer 110A and a second base layer 110B facing the first base layer 110A; and an aerogel-containing layer 120 stacked between the first base layer 110A and the second base layer 110B.

The aerogel-containing layer may be formed using the composition for the aerogel-containing layer that includes the fibrous support, the aerogel, the first binder, and the binder which melting point ranges from about 30° C. to about 80° C. as the second binder. This is described below.

Hereinafter, a method of preparing the heat insulating sheet according to one example embodiment is described.

The method of preparing the heat insulating sheet may include preparing a composition for an aerogel-containing layer that includes a fibrous support, an aerogel, a first binder, and a meltable binder which melting point ranges from about 30° C. to about 80° C. as a second binder, coating a first base layer with the composition for the aerogel-containing layer, and drying the composition for the aerogel-containing layer coated on the first base layer to prepare the heat insulating sheet.

The composition for the aerogel-containing layer includes the fibrous support, the aerogel, the first binder, and the meltable binder which melting point ranges from about 30° C. to about 80° C. as the second binder. The fibrous support, the aerogel, the first binder, and the meltable binder which melting point ranges from about 30° C. to about 80° C. as the second binder are the same as described above.

The composition for the aerogel-containing layer may further include one or more of the above-described dispersant, silane-based compound, and additive.

The composition for the aerogel-containing layer may further include a solvent.

The solvent may include one or more of a polar solvent and a nonpolar solvent.

The polar solvent may include at least one of water, an alcohol-based solvent, or a combination thereof. For example, the water may include at least one of purified water, deionized water, or a combination thereof. For example, the alcohol-based solvent may include one or more of methanol, ethanol, propanol, pentanol, butanol, hexanol, ethylene glycol, propylene glycol, diethylene glycol, and glycerol.

The nonpolar solvent may include a hydrocarbon-based solvent. For example, the hydrocarbon-based solvent may include one or more of an aliphatic hydrocarbon solvent such as at least one of hexane, pentane, or heptane, for example, an alkane solvent, and an aromatic hydrocarbon solvent such as toluene or benzene.

For example, the solvent may include water. When the water is included as the solvent, raw material costs and postprocessing costs can be effectively reduced.

The solvent may be included so that a weight ratio between the solvent and the total solid content of the composition for the aerogel-containing layer ranges from about 1:1 to about 90:1. For example, the solvent:total solid content weight ratio of the composition for the aerogel-containing layer may range from about 50:1 to about 70:1, from 20:1 to 30:1, or from 2:1 to 10:1. Within the above range, the composition for the aerogel-containing layer may be coated by controlling the viscosity of the composition for the aerogel-containing layer.

The composition for the aerogel-containing layer may be prepared using the solvent, the fibrous support, the aerogel, the binder, and the meltable binder which melting point ranges from about 30° C. to about 80° C.

According to one example embodiment, the composition for the aerogel-containing layer may be prepared by preparing a first mixed solution by mixing the binder and the binder which melting point ranges from about 30° C. to about 80° C. with the solvent; preparing a second mixed solution by mixing the aerogel with the first mixed solution; and preparing the composition for the aerogel-containing layer by mixing the fibrous support with the second mixed solution. In the preparing of the first mixed solution, the dispersant, the silane-based compound, the additive, or the like may be additionally mixed.

In each of, or at least one of, the first step, the second step, and the preparing of the composition for the aerogel-containing layer, mixing may be performed using a mixer. For example, a planetary mixer, a Thinky mixer, or the like may be used as the mixer.

The planetary mixer may include one or more types of planetary blades, and one or more types of high-speed dispersion blades. The planetary blades and high-speed dispersion blades continuously rotate about their axes. The rotational speed may be expressed in rotations-per-minute (rpm).

According to one example embodiment, the planetary mixer may include a first blade and a second blade which rotational axes are different. For example, the first blade may be a low-speed blade, and the second blade may be a high-speed blade. Herein, the low speed and high speed refer to relative rotational speeds. For example, the first blade may be an open blade, and the second blade may be a Despa blade. For example, the rotational speed of the first blade may range from about 10 rpm to about 100 rpm or from 10 rpm to 60 rpm. The rotational speed of the second blade may range from about 100 rpm to 2,000 rpm.

The aerogel-containing layer may be prepared by applying and drying the composition for the aerogel-containing layer. The drying may be performed at a temperature ranging from about 25° C. to about 100° C., from 45° C. to 90° C., or from 60° C. to 85° C. Within the above range, an aerogel-containing layer with desired or improved mechanical strength may be formed without a separate adhesive member or an adhesive, while reducing or preventing peeling between the first base layer and the aerogel-containing layer, and between the aerogel-containing layer and the second base layer.

According to one example embodiment, prior to performing the drying, the second base layer may be additionally stacked on the applied composition for the aerogel-containing layer.

Another example embodiment includes a rechargeable lithium battery module including a plurality of battery cells that face each other; and heat insulating sheets for a rechargeable lithium battery that are between the plurality of battery cells.

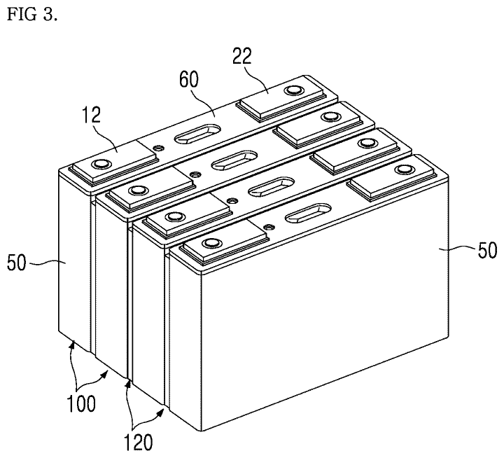

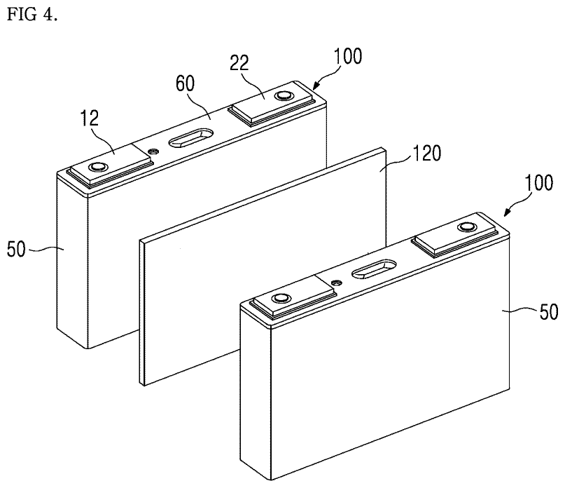

FIGS. 3 and 4 are a perspective view and an exploded perspective view, respectively, of a rechargeable lithium battery module, according to one example embodiment.

Referring to FIGS. 3 and 4, a rechargeable lithium battery module may include a plurality of battery cells 100 that face each other; and heat insulating sheets 200 for a rechargeable lithium battery between the battery cells 100.

The heat insulating sheet 200 for a rechargeable lithium battery has a plate shape. One surface of the heat insulating sheet 200 may come in contact with one surface of one battery cell 100, and the other surface of the heat insulating sheet 200 opposite to the one surface thereof may come in contact with one surface of another battery cell 100.

The battery cell 100 may include a case 50 configured to accommodate an electrode assembly including a positive electrode and a negative electrode; a cap plate 60 coupled to the case 50 to seal the case 50; and a positive electrode terminal 12 and a negative electrode terminal 22 electrically connected to the positive electrode and the negative electrode of the electrode assembly and protruding to the outside of the cap plate 60.

The positive electrode may include a current collector and a positive electrode active material layer formed on the current collector. The positive electrode active material layer may include a positive electrode active material, and may further include a binder and/or a conductive additive.

The content of the positive electrode active material may range from about 90 wt % to about 99.5 wt % with respect to 100 wt % of the positive electrode active material layer, and the content of the binder and the content of the conductive additive may each be in a range of about 0.5 wt % to about 5 wt % with respect to 100 wt % of the positive electrode active material layer.

Al may be included as the current collector, but the current collector is not limited thereto.

As the positive electrode active material, a compound capable of reversible intercalation and deintercalation of lithium (a lithiated intercalation compound) may be used. For example, one or more of composite oxides of lithium and a metal such as or including at least one of cobalt, manganese, nickel and a combination thereof may be included.

The composite oxides may be or include lithium transition metal composite oxides.

Examples of the composite oxides may include at least one of lithium nickel oxide, lithium cobalt oxide, lithium manganese oxide, a lithium iron phosphate compound, cobalt-free nickel-manganese oxide, or a combination thereof.

As one example, a compound represented by any one of the following chemical formulas may be included as the composite oxide. LiₐA_{1-b}XbO_{2-c}D_{c} (0.90≤a≤1.8, 0≤b≤0.5, 0≤c≤0.05); LiₐMn_{2-b}XbO_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The negative electrode includes a current collector and a negative electrode active material layer located on the current collector. The negative electrode active material layer may include a negative electrode active material, and may further include a binder and/or a conductive additive.

For example, the negative electrode active material layer may include about 90 wt % to about 99 wt % of the negative electrode active material, about 0.5 wt % to about 5 wt % of the binder, and about 0 wt % to about 5 wt % of the conductive additive.

The negative electrode active material includes at least one of a material capable of reversible intercalation/deintercalation of lithium ions, lithium metal, a lithium metal alloy, a material capable of doping and dedoping lithium, or a transition metal oxide.

The material capable of reversible intercalation/deintercalation of lithium ions is a carbon-based negative electrode active material, and may include, for example, crystalline carbon, amorphous carbon, or a combination thereof. Examples of the crystalline carbon may include graphite such as natural graphite or artificial graphite, and examples of the amorphous carbon may include at least one of soft carbon, hard carbon, mesophase pitch carbide, and calcinated coke.

A Si-based negative electrode active material or an Sn-based negative electrode active material may be included as the material capable of doping and dedoping lithium. The Si-based negative electrode active material may be or include at least one of silicon, a silicon-carbon composite, SiOₓ (0<x<2), an Si-based alloy, or a combination thereof.

The silicon-carbon composite may be or include a composite of silicon and amorphous carbon. According to one example embodiment, the silicon-carbon composite may include a silicon particle, and amorphous carbon coated on a surface of the silicon particle.

The silicon-carbon composite may further include crystalline carbon. For example, the silicon-carbon composite may include a core including crystalline carbon and a silicon particle, and an amorphous carbon coating layer located on a surface of the core.

A nonaqueous binder, an aqueous binder, a dry binder, or a combination thereof may be included as the binder. When the aqueous binder is included as the negative electrode binder, a cellulose-based compound that can impart viscosity may be further included.

As the negative electrode current collector, at least one of copper foil, nickel foil, stainless steel foil, titanium foil, nickel foam, copper foam, a polymer substrate having a conductive metal coated thereon, or combinations thereof, may be included.

An electrolyte for a rechargeable lithium battery includes a nonaqueous organic solvent and a lithium salt.

The nonaqueous organic solvent is configured as a medium through which ions involved in an electrochemical reaction of a battery can move.

The nonaqueous organic solvent may be or include at least one of a carbonate-based, ester-based, ether-based, ketone-based, or alcohol-based solvent, an aprotic solvent, or a combination thereof. Any of the above may be included alone as the nonaqueous organic solvent, or two or more of the above may be mixed and included as the nonaqueous organic solvent.

Also, when the carbonate-based solvent is included, a cyclic carbonate and a chain carbonate may be mixed.

A separator may be present between a positive electrode and a negative electrode according to the type of rechargeable lithium battery. At least one of polyethylene, polypropylene, polyvinylidene fluoride, or a multi-layer film of two or more thereof may be included as the separator.

The separator may include a porous base, and a coating layer located on one surface, or both surfaces, of the porous base, and including at least one of an organic material, an inorganic material, or a combination thereof.

The organic material may include a polyvinylidene fluoride-based polymer or a (meth)acryl-based polymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be mixed in a single coating layer, or may be in a form in which a coating layer including the organic material and a coating layer including the inorganic material are stacked together.

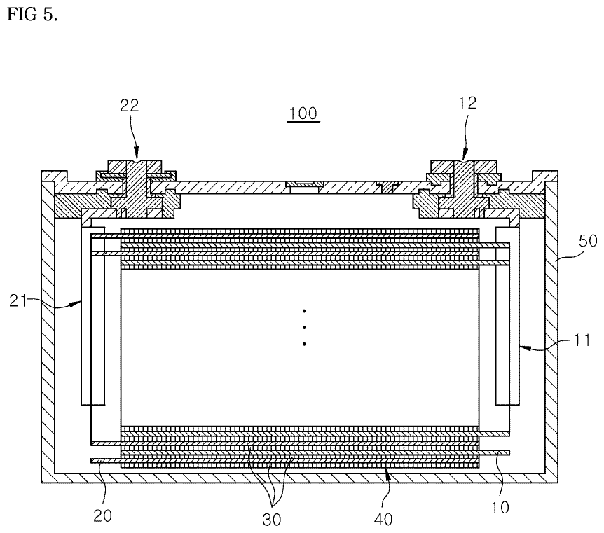

FIG. 5 is a cross-sectional view schematically showing the battery cell 100, according to one embodiment.

Referring to FIG. 5, the battery cell 100 may include an electrode assembly 40 including a positive electrode 10, a negative electrode 20, and a separator 30 interposed between the positive electrode 10 and the negative electrode 20; a case 50 in which the electrode assembly 40 is accommodated; a positive electrode lead tab 11 connected to the positive electrode 10; a positive electrode terminal 12 connected to the positive electrode lead tab 11; a negative electrode lead tab 21 connected to the negative electrode 20; and a negative electrode terminal 22 connected to the negative electrode lead tab 21.

The rechargeable lithium battery module according to one example embodiment may be applicable to vehicles, mobile phones, and/or various other forms of electric devices, but the present disclosure is not limited thereto.

The battery module according to the above-described example embodiment may be included in manufacturing a battery pack.

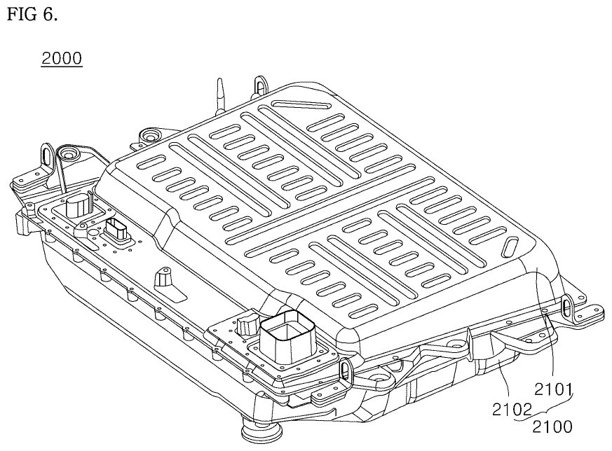

FIG. 6 is a view illustrating a battery pack, according to one example embodiment.

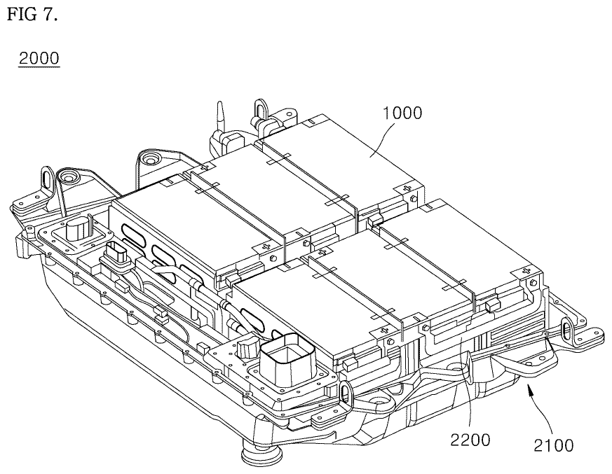

FIG. 7 is a view illustrating a battery pack, according to one example embodiment.

A battery pack 2000 according to one example embodiment includes an assembly of electrically connected individual batteries, and a pack case accommodating the individual batteries. In the drawings, for convenience of illustration of the drawings, illustration of components such as a busbar, a cooling unit, an external terminal, and the like for electrical connection of batteries has been omitted.

For example, the battery pack 2000 may include a plurality of battery modules 1000 (for example, including the battery module described above with reference to FIG. 5) and a pack case 2100 for accommodating the battery modules 1000 therein. For example, the pack case 2100 may include first and second pack cases 2101 and 2102 coupled to each other in directions facing each other with the plurality of battery modules 1000 are interposed therebetween. The plurality of battery modules 1000 may be electrically connected to each other using a busbar 2200, or the plurality of battery modules 1000 may be electrically connected to each other in series or in parallel, or by a combination of serial and parallel connections, to obtain a required electrical output.

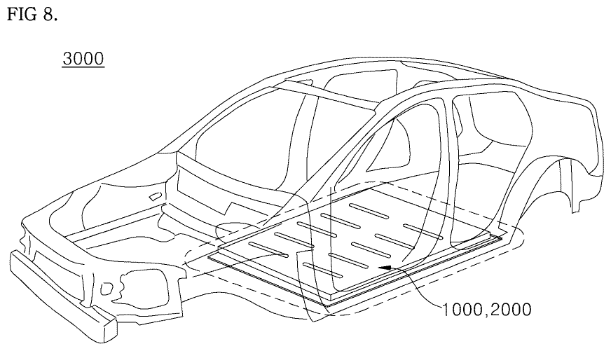

FIG. 8 is a view illustrating a vehicle body and vehicle body components, according to one example embodiment.

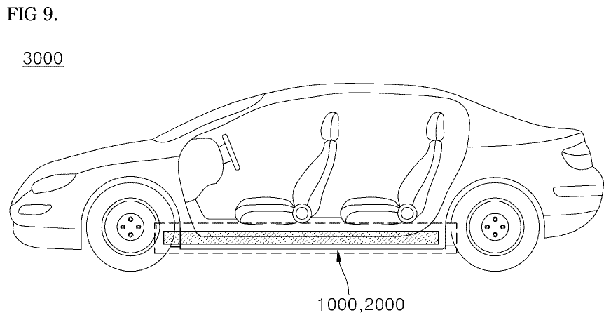

FIG. 9 is a view illustrating a vehicle body and vehicle body components, according to one example embodiment.

The battery pack 2000 according to one example embodiment described above with reference to FIGS. 6 and 7 may be mounted in a vehicle 3000. For example, the vehicle 3000 may be an electric vehicle, a hybrid vehicle, or a plug-in hybrid vehicle. The vehicle may be, e.g., a four-wheel vehicle or a two-wheel vehicle.

As illustrated in FIGS. 8 and 9, the vehicle 3000 according to one example embodiment includes the battery modules 1000 and/or the battery pack 2000 including the battery modules 1000 according to one example embodiment of the present disclosure. The vehicle 3000 operates by receiving power from the battery modules 1000 and/or the battery pack 2000 including the battery modules 1000 according to one example embodiment of the present disclosure.

Hereinafter, examples and comparative examples of the present disclosure are described. However, the following examples are merely example embodiments of the present disclosure, and the present disclosure is not limited to the following examples.

### Example 1

### Preparation of Meltable Binder Having Melting Point of 38° C.

Toluene was added as a solvent in a 1 L reactor equipped with a cooling device to reflux nitrogen gas and facilitate temperature control. 100 parts by weight of a monomer mixture including 98 mol % of stearyl (meth)acrylate (STMA) and 2 mol % of silicone acrylate (Shin-Etsu Chemical Co., Ltd., KF-2012) was added to the reactor. Nitrogen gas was input to the monomer mixture for 30 minutes to remove oxygen therefrom, and the temperature inside the reactor was maintained at 70° C. The monomer mixture was uniformly stirred, and 0.2 parts by weight of a V-601 initiator (azo-based radical initiator, Wako Chemicals Co., Ltd.) was input and allowed to react for 4 hours at 70° C. to prepare a binder formed of STMA and silicone acrylate (melting point: 38° C.). Toluene was added as a solvent to prepare a binder solution (solid weight: 30 wt %).

### Preparation of Composition for Aerogel-Containing Layer

Polyvinyl alcohol (PVA, Sigma-Aldrich Co., Ltd.) as a first binder and the prepared meltable binder having a melting point of 38° C. were input to deionized water as a solvent and mixed at 30 rpm with an open blade and at 700 rpm with a Despa blade to prepare a first mixed solution. An aerogel (having a BET specific surface area of 800 m²/g) was input to the first mixed solution and mixed at 70 rpm with the open blade and at 1,500 rpm with the Despa blade to prepare a second mixed solution. Glass wool was input to the second mixed solution and mixed at 30 rpm with the open blade and at 1,200 rpm with the Despa blade to prepare a composition for an aerogel-containing layer. A planetary mixer (DNTEK Co., Ltd., PT-005) was included for mixing.

The prepared composition for an aerogel-containing layer was in the form of a slurry and included, based on solid content, 50 wt % aerogel, 40 wt % glass wool, 9 wt % PVA, and 1 wt % meltable binder having a melting point of 38° C., while not including the adhesion promoter included in Comparative Example 4.

### Preparation of Heat Insulating Sheet

The prepared composition for an aerogel-containing layer was applied on a mica sheet (Famica, Muscovite) having a thickness of 0.1 mm, which was a first base layer, and a mica sheet (Famica, Muscovite) having a thickness of 0.1 mm as a second base layer was stacked on the composition for an aerogel-containing layer and coated by a rolling method. Subsequently, drying was performed for 24 hours at 60° C. to prepare a heat insulating sheet stacked in the order of mica sheet-aerogel-containing layer-mica sheet. A thickness of the aerogel-containing layer in the prepared heat insulating sheet was 2.0 mm.

### Example 2

A heat insulating sheet was prepared in the same manner as in Example 1, with a difference that in Example 1, the solid content in the composition for an aerogel-containing layer was changed to 50 wt % aerogel, 40 wt % glass wool, 7 wt % PVA, and 3 wt % meltable binder having a melting point of 38° C. of Example 1.

### Example 3

A heat insulating sheet was prepared in the same manner as in Example 1, with a difference that in Example 1, the solid content in the composition for an aerogel-containing layer was changed to 50 wt % aerogel, 40 wt % glass wool, 5 wt % PVA, and 5 wt % meltable binder having a melting point of 38° C. of Example 1.

### Example 4

A heat insulating sheet was prepared in the same manner as in Example 1, with a difference that in Example 1, the solid content in the composition for an aerogel-containing layer was changed to 40 wt % aerogel, 40 wt % glass wool, 15 wt % PVA, and 5 wt % meltable binder having a melting point of 38° C. of Example 1.

### Example 5

A heat insulating sheet was prepared in the same manner as in Example 1, with a difference that in Example 1, the solid content in the composition for an aerogel-containing layer was changed to 55 wt % aerogel, 40 wt % glass wool, 4 wt % PVA, and 1 wt % meltable binder having a melting point of 38° C. of Example 1.

### Example 6

A heat insulating sheet was prepared in the same manner as in Example 1, with a difference that in Example 1, the solid content in the composition for an aerogel-containing layer was changed to 60 wt % aerogel, 30 wt % glass wool, 7 wt % PVA, and 3 wt % meltable binder having a melting point of 38° C. of Example 1.

### Example 7

### Preparation of Meltable Binder Having a Melting Point of 38° C.

Toluene was added as a solvent in a 1 L reactor equipped with a cooling device to reflux nitrogen gas and facilitate temperature control. 100 parts by weight of a monomer mixture including 95 mol % of stearyl (meth)acrylate (STMA) and 5 mol % of t-butyl acrylate was added to the reactor. Nitrogen gas was input to the monomer mixture for 30 minutes to remove oxygen therefrom, and then the temperature inside the reactor was maintained at 76° C. The monomer mixture was uniformly stirred, and 0.2 parts by weight of a V-601 initiator (azo-based radical initiator, Wako Chemicals Co., Ltd.) was input and allowed to react for 4 hours at 70° C. to prepare a meltable binder formed of STMA and t-butyl acrylate (melting point: 38° C.). Toluene was added as a solvent to prepare a binder solution (solid weight: 30 wt %).

A heat insulating sheet was prepared in the same manner as in Example 2 using the prepared meltable binder having a melting point of 38° C.

### Comparative Example 1

A heat insulating sheet was prepared in the same manner as in Example 1, with a difference that in Example 1, the solid content in the composition for an aerogel-containing layer was 50 wt % aerogel, 40 wt % glass wool, and 10 wt % PVA.

### Comparative Example 2

A heat insulating sheet was prepared in the same manner as in Example 1, with a difference that in Example 1, the solid content in the composition for an aerogel-containing layer was 55 wt % aerogel, 40 wt % glass wool, and 5 wt % PVA.

### Comparative Example 3

A heat insulating sheet was prepared in the same manner as in Example 1, with a difference that in Example 1, the solid content in the composition for an aerogel-containing layer was 40 wt % aerogel, 40 wt % glass wool, and 20 wt % PVA.

### Comparative Example 4

A heat insulating sheet was prepared in the same manner as in Example 1, with a difference that in Example 1, BYK-4500 (non-silicon-based adhesion promoter) was included as an adhesion promoter instead of the meltable binder having a melting point of 38° C., and the solid content was 50 wt % aerogel, 40 wt % glass wool, 9 wt % PVA, and 1 wt % BYK-4500 as the adhesion promoter.

The following physical properties were evaluated for the heat insulating sheets prepared in Examples and Comparative Examples.
1) Heat insulating performance (units: ° C.): The prepared heat insulating sheets were cut into a length of 232 mm and a width of 115 mm to prepare samples, each sample was placed between a pair of aluminum plates having a thickness of 1 mm and facing each other and was placed on a heat press, an upper plate of the heat press was heated to 350° C., and a lower plate of the heat press was maintained at a starting temperature of 40° C. without being heated. Then, a pressure of 20 kN was applied to the lower plate of the heat press, and the temperature of the lower plate of the heat press was measured after 11 minutes. The lower the temperature of the lower plate, the better the heat insulating performance of the heat insulating sheet.
2) Resistance to flame passage (units: seconds): The prepared heat insulating sheets were cut into a length of 100 mm and a width of 70 mm to prepare samples, and a temperature sensor was mounted on each sample. Using a torch capable of emitting flames, flames were applied to the side of each sample where the temperature sensor was mounted until the temperature of the surface of each sample reached 1,200° C. Here, the time taken for each sample to collapse due to cracks formed thereon was checked. A longer time indicates better resistance to flame passage.
3) Adhesive strength (units: gf/inch): The prepared heat insulating sheets were cut into a length of 150 mm and a width of 1 inch to prepare samples. Using a texture analyzer (TA Industry Co., Ltd.) as a tensile tester based on JISZ2037 at 23° C. and a relative humidity of 50%, an adhesive strength between the aerogel-containing layer and the first base layer (or the second base layer) was measured for the prepared samples using a T-peel force measurement method with a peel temperature of 25° C., a peel speed of 2,400 mm/min, and a peel angle of 180°.
4) 3-point bending, flexural modulus (units: Mpa): Each heat insulating sheet was prepared into samples according to the ASTM D790 standard, and the flexural modulus was measured using a UTM (UT-005E) of MTDI Co., Ltd. Specifically, through the 3-point bending analysis method, the prepared samples were placed on a support, a force was applied to the center of each sample at a speed ranging from 1 mm/min to 10 mm/min, a load was recorded, and an initial slope value obtained by dividing the load by 15% strain was measured to measure the flexural modulus at 15% strain. The lower the flexural modulus, the better the flexibility of the heat insulating sheet.
5) Punchability: The processability of punching was evaluated. Each of the prepared heat insulating sheets was cut, and the cut surfaces of the heat insulating sheets were checked by visual inspection. The case in which the cut surface was smooth and there was no residue was designated as “⊙,” the case in which the cut surface was smooth but there was some residue was designated as “0,” the case in which the cut surface was bumpy instead of being smooth and there was some residue was designated as “Δ,” and the case in which the cut surface was bumpy instead of being smooth and there was a large amount of residue was designated as “X”.
6) Dust resistance (units: %): The prepared heat insulating sheets were cut into a length of 12 inch and a width of 12 inch to prepare samples, and the weight of each of the samples was measured. The samples were vibrated under vibration conditions (frequency: 24 Hz/3 mm, vibration duration: 6 hours) using a vibration tester (ASTM C592-04), and then the weights of the samples were measured. A weight reduction rate was evaluated according to the following equation. The lower the weight reduction rate, the better the dust resistance.

$$Weight reduction rate = [ ( weight of sample before vibration ) - ( weight of sample after vibration ) ] / ( weight of sample before vibration ) \times 100$$

TABLE 1

| | | | | | | Heat | Resistance | | | | |
|---|---|---|---|---|---|---|---|---|---|---|---|
| | Aerogel-containing layer | | | | | insulating | to flame | Adhesive | 3-point | | Dust |
| | | Glass | First | Meltable | Adhesion | performance | passage | strength | bending | | resistance |
| | Aerogel | wool | binder | binder | promoter | (° C.) | (s) | (gf/in) | (Mpa) | Punchability | (%) |
| Example 1 | 50 | 40 | 9 | 1 | 0 | 79.2 | 623 | 109 | 0.127 | ⊙ | 0.00 |
| Example 2 | 50 | 40 | 7 | 3 | 0 | 78.3 | 619 | 110 | 0.149 | ⊙ | 0.00 |
| Example 3 | 50 | 40 | 5 | 5 | 0 | 79.2 | 632 | 112 | 0.151 | ⊙ | 0.00 |
| Example 4 | 40 | 40 | 15 | 5 | 0 | 83.5 | 609 | 116 | 0.160 | ⊙ | 0.00 |
| Example 5 | 55 | 40 | 4 | 1 | 0 | 79.5 | 630 | 96 | 0.116 | ◯ | 0.00 |
| Example 6 | 60 | 30 | 7 | 3 | 0 | 77.5 | 619 | 111 | 0.146 | ⊙ | 0.00 |
| Example 7 | 50 | 40 | 7 | 3 | 0 | 78.9 | 621 | 109 | 0.147 | ⊙ | 0.00 |
| Comparative | 50 | 40 | 10 | 0 | 0 | 80.6 | 611 | 11 | 0.039 | X | 0.12 |
| Example 1 | | | | | | | | | | | |
| Comparative | 55 | 40 | 5 | 0 | 0 | 79.4 | 618 | 5 | 0.027 | X | 0.16 |
| Example 2 | | | | | | | | | | | |
| Comparative | 40 | 40 | 20 | 0 | 0 | 84.1 | 590 | 19 | 0.046 | X | 0.09 |
| Example 3 | | | | | | | | | | | |
| Comparative | 50 | 40 | 9 | 0 | 1 | 79.9 | 612 | 28 | 0.042 | X | 0.11 |
| Example 4 | | | | | | | | | | | |

As indicated in Table 1 above, the heat insulating sheets of Examples provided desired or improved heat insulating performance, desired or improved adhesion between a base layer and an aerogel-containing layer, and desired or improved dust resistance, punchability, and flexibility.

On the other hand, in the heat insulating sheets of Comparative Examples 1 to 3 that did not contain the meltable binder having a melting point ranging from about 30° C. to about 80° C., the adhesive strength was generally low, and the flexibility, dust resistance, and punchability were also not good. In the heat insulating sheet of Comparative Example 4 in which the adhesion promoter was included instead of the meltable binder having a melting point ranging from about 30° C. to about 80° C., the adhesive strength was lower, and the flexibility, dust resistance, and punchability were also inferior compared to Examples.

A heat insulating sheet for a rechargeable lithium battery according to one example embodiment provides desired or improved heat insulating performance, thereby reducing or suppressing heat propagation and/or heat transfer in a module and improving the safety of the module. Due to having high adhesion between a base layer and an aerogel-containing layer, the heat insulating sheet for a rechargeable lithium battery according to one example embodiment can secure sufficient heat insulating performance and improve flexibility, punchability, dust resistance, and handlability.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A heat insulating sheet for a rechargeable lithium battery, the heat insulating sheet comprising:
a first base layer and an aerogel-containing layer that are stacked together,
wherein the aerogel-containing layer includes a fibrous support, an aerogel, a first binder, and a second binder, and
the second binder comprises a meltable binder with a melting point that ranges from about 30° C. to about 80° C.

2. The heat insulating sheet of claim 1, wherein a second base layer is further stacked on the aerogel-containing layer.

3. The heat insulating sheet of claim 1, wherein the aerogel-containing layer is a separate layer independent of the first base layer.

4. The heat insulating sheet of claim 2, wherein the aerogel-containing layer is a separate layer independent of the second base layer.

5. The heat insulating sheet of claim 1, wherein the first binder has a higher melting point than the meltable binder.

6. The heat insulating sheet of claim 1, wherein the meltable binder is included in an amount ranging from about 0.1 wt % to about 15 wt % in the aerogel-containing layer.

7. The heat insulating sheet of claim 1, wherein the meltable binder comprises a copolymer of a monomer mixture including (meth)acrylate having a C16 to C22 linear or branched alkyl group.

8. The heat insulating sheet of claim 7, wherein the monomer mixture further comprises one or more of a silicon-based monomer and a non-silicon-based monomer.

9. The heat insulating sheet of claim 1, wherein the first binder comprises one or more of polyvinyl alcohol, polyethylene glycol, polyacrylamide, polyvinyl pyrrolidone, polyurethane, and polyester.

10. The heat insulating sheet of claim 1, wherein the fibrous support comprises glass wool.

11. The heat insulating sheet of claim 1, wherein the aerogel-containing layer comprises about 5 wt % to about 70 wt % of the fibrous support, about 10 wt % to about 90 wt % of the aerogel, about 0.5 wt % to about 20 wt % of the first binder, and about 0.1 wt % to about 15 wt % of the meltable binder.

12. The heat insulating sheet of claim 1, wherein the first base layer comprises a mica sheet.

13. The heat insulating sheet of claim 2, wherein the second base layer comprises a mica sheet.

14. A rechargeable lithium battery module comprising:
a plurality of battery cells that face each other; and
the heat insulating sheet of claim 1 between the plurality of battery cells.
